(19) United States
(12) Patent Application Publication
(10) Pub. No.: US 2009/0116153 A1
(43) Pub. Date: May 7, 2009

(54) POWER CONVERSION SYSTEM AND OVER-LOAD PROTECTION DEVICE THEREOF

(76) Inventors: Chien-Liang Lin, Hsin-Chu (TW); Yu-Chuan Liu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/934,789

(22) Filed: Nov. 5, 2007

(51) Int. Cl. H02H 7/10

(52) U.S. Cl. 361/18

(57) ABSTRACT

A power conversion system and over-load protection device thereof includes a first detection circuit, a charging/discharging circuit, and a second detection circuit. The discharging/charging circuit charges based on a feedback signal relative to output of the power conversion system. A switching-disabling control signal is produced based on the charge of the discharging/charging circuit, to disable the power conversion system.

### BACKGROUND OF THE INVENTION

1. Field of the Invention

The present invention relates to a power conversion system, and particularly to a power conversion system and an over-load protection device thereof.

2. Description of the Prior Art

Please refer to FIG. 1, which is a schematic diagram illustrating a prior art fly back power converter. An output terminal of the power converter drives a load L. A pulse-width modulation (PWM) signal generating circuit 110 outputs a PWM signal Vg, which controls the switching of a power switch Q1 to transform an input voltage V1 at a primary side of the transformer T to a secondary side of the transformer T, such that an output voltage V0 is generated. A sensing resistor Rcs is serially coupled to the power switch Q1, is used to obtain a sensing voltage Vcs proportional to a primary side current Ip flowing through the power switch Q1. The PWM signal generating circuit 110 controls a duty cycle of the PWM signal Vg according to a feedback signal Vf and the sensing voltage Vcs, to thereby stabilize the output voltage V0 of the power converter.

For a soft-start application, a charging current source 120 starts to charge an external capacitor 130 when the power conversion system is turned on. Meanwhile, the feedback signal Vf is coupled to a charging voltage Sv of the capacitor 130 via a clamping diode 140. At the same time, the feedback signal Vf is equal to the charging voltage Sv of the capacitor 130 plus a bias voltage (Vd) of the clamping diode 140; that is, Vf=Sv+Vd. Therefore, the feedback signal Vf slowly increases following the charging voltage Sv during the soft-start period, and the primary side current Ip also slowly increases to prevent an inrush condition of the power converter.

After the soft-start period, the voltage of feedback signal Vf is controlled by the feedback control circuit 150. In other words, the feedback signal Vf is relative to the output terminal voltage V0 and the load L, and has no relation to the charging voltage of the external capacitor 130, That is, the voltage of the feed back signal Vf is proportional to the load L.

When the load L is over a predetermined value,—that is, over-load—the feedback signal Vf is over a reference voltage Vref, and a comparator 160 generates an over-load signal OLP. The over-load signal OLP will be checked by a debounce circuit 170. That is, if the over-load signal OLP exceeds the threshold for longer than a rated time of the debounce circuit 170, the debounce circuit 170 sends an over-load checking signal OLP1 to the PWM signal generating circuit 110, and the PWM signal generating circuit 110 stops generating the PWM signal Vg, such that the power converter can be protected.

When a user has an over-load requirement of a short period of time, in order for the power converter to work normally, the time requirement for over-load should be controlled to be less than the rated time of the debounce circuit 170, to prevent the PWM signal generating circuit 110 from stopping generating the PWM signal.

However, if the over-load requirement time needs to be longer to obtain more over-energy, then the resistance value of the detection resistor Rcs should be decreased to increase the threshold value of over-energy protection such that the rated value of the power switch Q1, the transformer T and the input terminal components (for example, an input capacitor or a rectifier) will increase. Doing so, however, means that material costs will increase.

### SUMMARY OF THE INVENTION

Therefore, a main purpose of the present invention is to provide a power conversion system with an over-load protection device and an over-load protection device thereof, to solve the problems of inflexibility in the over-load protection existing in the prior art.

A power conversion system with an over-load protection device disclosed by the present invention includes a transformer, a feedback control circuit, a power switch, a PWM signal generating circuit, and an over-load protection device. A primary winding of the transformer is serially coupled to the power switch. The feedback control circuit is used for outputting a feedback signal, which is correlated to a load of the output terminal of the power conversion system. The PWM signal generating circuit is used for generating a pulse-width modulation (PWM) signal to switch the power switch and to determine a duty cycle of the PWM signal according to the feedback signal. The over-load protection device generates a switching-disabling control signal according to the feedback signal. The PWM signal generating circuit stops generating the PWM signal according to the switching-disabling control signal.

The over-load protection device includes a charging/discharging circuit, a first detection circuit and a second detection circuit. The first detection circuit, is used for receiving the feedback signal and for detecting an over-load event of the power conversion system according to a voltage of the feedback signal. The charging/discharging circuit is used for charging before the power the over-load event occurs, and for discharging according to the over-load event. The second detection circuit is used for detecting a discharging of the charging/discharging circuit, and for generating the switching-disabling control signal when a charging voltage of the charging/discharging circuit is discharged to a predetermined level.

The charging/discharging circuit can comprise a capacitor, a charging current source, and a variable resistor. The capacitor is coupled to the second detection circuit and the variable resistor. The charging current source is used for charging the capacitor, and stops charging the capacitor when the over-load event occurs, such that the capacitor discharges. The variable resistor is used for providing a path for the capacitor for discharging, wherein a resistance value of the variable resistor is determined according to a voltage value of the feedback signal.

Also, a discharging current source can replace the variable resistor to provide a discharging path for the capacitor. The discharging current source can be a variable current source, and the current value of which is determined according to a voltage of the feedback signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a prior art flyback power converter.

FIG. 2 is a schematic diagram illustrating an over-load protection device according to a first embodiment of the present invention.

FIG. 3 illustrates the relation between the voltage and discharging time of the over-load protection device according to the present invention.

FIG. 4 is a schematic diagram illustrating an over-load protection device according to a second embodiment of the present invention.

### DETAILED DESCRIPTION

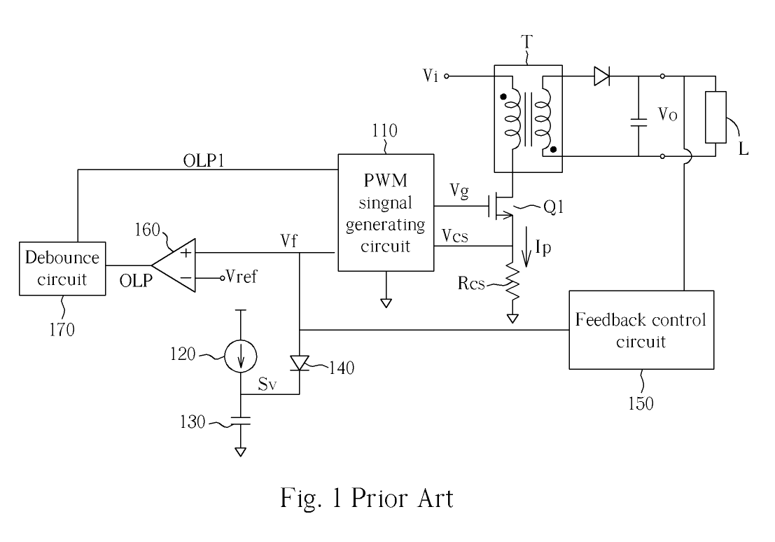

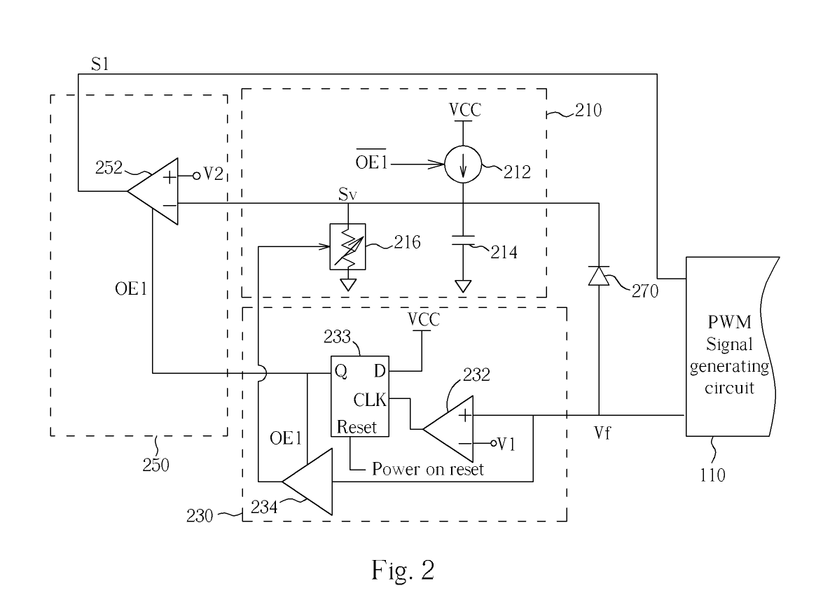

Please refer to FIG. 2, which is an over-load protection device according to the present invention. The over-load protection device is applied to a power conversion system. Also, an output terminal of the power conversion system drives a load L (please jointly refer to FIG. 1).

The over-load protection device is coupled to a PWM (Pulse Width Modulation) signal generating circuit 110 of the power conversion system. The PWM signal generating circuit 110 can generate a PWM signal Vg according to a feedback signal Vf. Additionally, the over-load protection apparatus receives a feedback signal Vf according to a load level of the power conversion system output terminal. In this case, the voltage value of the feedback signal Vf is positively correlated to the load level.

The over-load protection device receives the feedback signal Vf and generates a switching-disabling control signal S1 according to the feedback signal Vf to stop the power conversion system. For example, the PWM signal generating circuit 110 stops outputting the PWM signal while receiving the switching-disabling control signal S1.

The over-load protection device includes a charging/discharging circuit 210, a first detection circuit 230 and a second detection circuit 250. The first detection circuit 230 is coupled between the PWM signal generating circuit 110 and the charging/discharging circuit 210, and the second detection circuit 250 is coupled between the charging/discharging circuit 210 and the PWM signal generating circuit 110. The first detection circuit 230 receives the feedback signal Vf and controls discharging of the charging/discharging circuit 210 according to the feedback signal Vf.

The second detection circuit 250 detects discharging of the charging/discharging circuit 210 and generates the switching-disabling control signal S1 according to the discharging of the charging/discharging circuit 210. The charging/discharging circuit 210 can comprise a charging current source 212, a capacitor 214 and a variable resistor 216. The current source 212 is coupled to the capacitor 214, and a connection point of the current source 212 and the capacitor 214 is coupled to the second detection circuit 250. Also, the variable resistor 216 is coupled in parallel to the capacitor 214.

Before an over-load event occurs, the charging current source 212 charges the capacitor 214, such that the capacitor is charged to a voltage level of a voltage source VCC. The charging current source 212 stops charging the capacitor 214 via the controlling of the first detection circuit 230, such that the capacitor 214 discharges through the variable resistor 216. Also, via controlling of the first detection circuit 230, the variable resistor 216 can adjust the discharging speed of the capacitor 214 according to the load level.

The first detection circuit 230 can comprise a comparator 232, a flip-flop 233 and a buffer 234. The comparator 232 receives the feedback signal Vf and compares it with a reference voltage V1 to check whether a condition of over-load is met; that is, whether an over-load event occurs. When a condition of over-load is met, at the moment that the feedback signal Vf is higher than the reference voltage V1, the output signal of comparator 232 transmits from logic low to logic high. As the flip-flop 233 can be triggered at a rising edge, the flip-flop 233 generates an enabling signal OE1 with a high logic level to enable the buffer 234, such that the buffer 234 transmits the feedback signal Vf to the variable resistor 216. The resistance value of the variable resistor can vary according to the feedback signal Vf; before the over-load event occurs, the resistance value of the variable resistor 216 can be regarded as infinity when the enable signal OE1 has a low logic value. Also, the enabling signal OE1 with high logic value will turn off the charging current source 212, so that a charging voltage Sv of the capacitor 214 discharges from the voltage VCC, the discharging speed of which is determined according to the value of the capacitor 214 and the resistance value of the variable resistor 216.

In this case, the buffer 234 can be replaced with an amplifier. The amplifier amplifies the received feedback signal Vf suitably when the amplifier is enabled by the enabling signal OE1 with a high logic value and transmits the amplified feedback signal Vf to the variable resistor 216 for adjusting resistance value of the resistor 216.

The second detection circuit 250 can include a comparator 252 controlled by the enabling signal OE1. An input terminal of the comparator 252 is coupled to a connection point of the charging current source 212 and the capacitor 214, and an output terminal of which is coupled to the PWM signal generating circuit 110. The comparator 252 can compares the charging voltage Sv with the reference voltage V2. When an over-load condition is detected, the capacitor 214 begins discharging and the charging voltage Sv gradually decreases. Also, when the charging voltage Sv is lower than a reference voltage V2, the comparator 252 is enabled by the enabling signal OE1 with a high logic level at this time, so the comparator 252 generates the switching-disabling control signal S1 with a high logic value. The signal S1 with a high logic level is inputted to the PWM signal generating circuit 110, such that the PWM signal generating circuit 110 stops outputting the PWM signal, and the power conversion system is turned off.

The over-load time period of the whole power conversion system is from the time of detection of the over-load condition to the time when the PWM signal generating circuit 110 receives the switching-disabling control signal S1. Therefore, the discharging time of the capacitor 214 will affect the length of over-load time; the faster the discharging speed of the capacitor 214, the shorter the discharging time, and the over-load time is shorter as well.

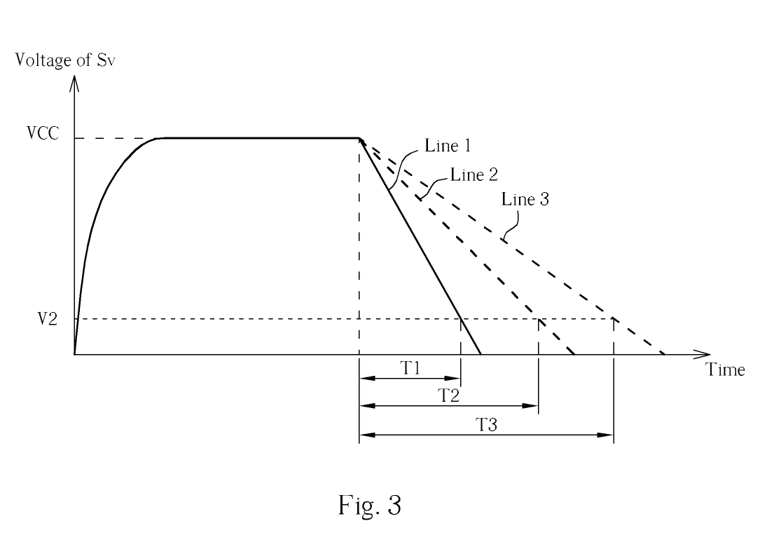

During an over-load period, if energy consumption is needed to be fixed, since over-load time (T) equals to energy (W) divided by power (P) (T=W/P), the over-load time is inversely proportional to the power level correspondingly. The larger the load of the conversion system is, the larger the power of the conversion system is. Therefore, when an over-load condition is detected, the larger the load of the conversion system is, the shorter the over-load time is. Please refer to FIG. 3. The larger the output terminal load, the larger the voltage value of the feedback signal Vf, the smaller the resistance value of the variable resistor 216, and the faster the discharging speed of the capacitor 214 (the shorter the discharging time). For example, the discharging time T1 is smaller than the discharging time T2, and likewise, the discharging time T2 is smaller than the discharging time T3. Correspondingly, the variable resistance value of the discharging time T1 is adjusted to be smaller than the variable resistance value of the discharging time T2, and the variable resistance value of the discharging time T2 is adjusted to be smaller than the variable resistance value of the discharging time T3.

Moreover, capacitor value of the capacitor 214 can also affect the length of the discharging time and the over-load time. Therefore, energy consumption during an over-load period can be adjusted by changing the capacitor value of the capacitor 214. Thus, if the over-load protection device is integrated to an integrated circuit, the capacitor can be external to the integrated circuit such that the energy consumption during an over-load period can be adjusted by changing the capacitor value of the external capacitor.

Also, there can be a diode 270 between the charging/discharging circuit 210 and the PWM signal generating circuit 110 to provide a soft-start protection. Please refer to FIG. 2 again, where the diode 270 is coupled between a connection of the charging/discharging current source 212 and the capacitor 214, and a feedback terminal of the PWM signal generating circuit 110.

In a time period beginning when the power conversion system is turned on, the charging current source 212 starts to charge the capacitor 214, and the feedback signal Vf is coupled to the charging voltage of the capacitor 214 via the diode 270. Therefore, the feedback signal Vf slowly increases following the charging voltage Sv of the capacitor 214 during the time period beginning when the power conversion system is turned on, therefore an inrush problem can be avoided.

The charging/discharging circuit 210 according to the present invention provides soft-start protection to the power conversion system during a system start-up period. After the start-up period, if the over-load event occurs, the comparator 252 generates the switching-disabling control signal S1 with logic high level when it detects that the discharging voltage Sv of the capacitor 214 is discharged to a predetermined level (reference voltage V2). As the comparator 252 is controlled by the enabling signal OE1. The comparator 252 generates the switching-disabling control signal S1 with logic high level only after the start-up period and the over-load event occurs to avoid erroneous operation during the soft-start period.

The over-load protection device can be integrated to the PWM signal generating circuit to form an integrated circuit, and also can be located external to an integrated circuit comprising the PWM signal generating circuit.

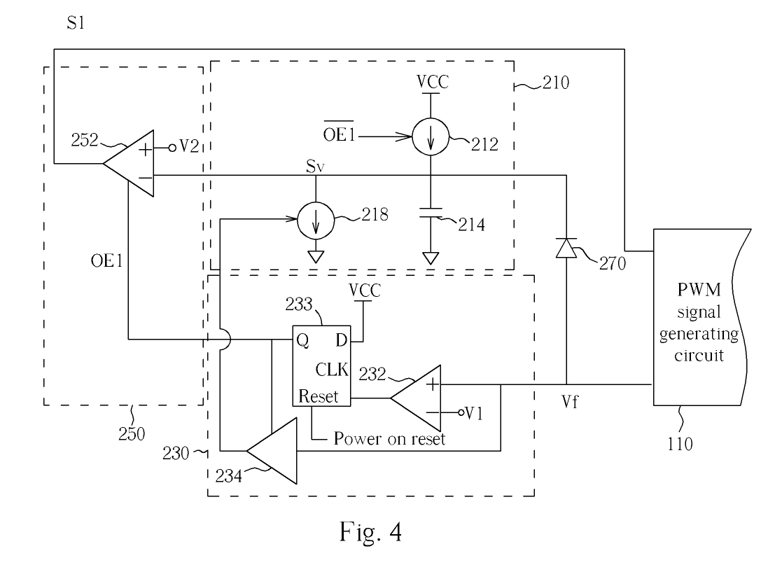

FIG. 4 is a schematic diagram illustrating an over-load protection device according to a second embodiment of the present invention. The variable resistor 216 in the first embodiment is replaced with a variable current source 218, which is a discharging current source in the second embodiment. Before the over-load event occurs, the enabling signal OE1 has a low logic value, and the current value of the variable current source 218 can be regarded as 0. After the over-load event occurs, the more the load of the power conversion system, the larger the voltage value of the feedback signal Vf, and thus the larger the current of the variable current source 218, and the faster the discharging speed of the charging voltage Sv of the capacitor 214. In short, the discharging time is shorter.

Those skilled in the art will readily observe that numerous modifications and alterations of the device and method may be made while retaining the teachings of the invention.

What is claimed is:

1. An over-load protection device for a power conversion system, the over-load protection device being used for generating a switching-disabling control signal according to a feedback signal relative to a load on the output terminal of the power conversion system, to turn off the power conversion system, wherein the over-load protection device comprises:
a first detection circuit, for receiving the feedback signal and for detecting an over-load event of the power conversion system according to a voltage of the feedback signal;
a charging/discharging circuit, for charging before the over-load event occurs, and for discharging according to the over-load event; and
a second detection circuit, for detecting a discharging of the charging/discharging circuit, and for generating the switching-disabling control signal when a charging voltage of the charging/discharging circuit is discharged to a predetermined level;
wherein the first detection circuit adjusts a discharging speed of the charging/discharging circuit according to an over-load level of the power conversion system when the over-load event occurs.

2. The over-load protection device of claim 1, wherein the charging/discharging circuit comprises:
a capacitor;
a charging current source, for charging the capacitor, and stopping charging the capacitor when the over-load event occurs, such that the capacitor discharges; and
a variable resistor, coupled to the capacitor, for providing a path for discharging of the capacitor, wherein a resistance value of the variable resistor is determined according to a voltage value of the feedback signal.

3. The over-load protection device of claim 1, wherein the charging/discharging circuit comprises:
a capacitor;
a charging current source, for charging the capacitor, and stopping charging the capacitor when the over-load event occurs, such that the capacitor discharges; and
a variable current source, coupled to the capacitor, for providing a path for discharging of the capacitor, wherein a current value of the adjustable current source is determined according to a voltage value of the feedback signal.

4. The over-load protection device of claim 1, wherein the charging/discharging circuit is further coupled to a diode, such that a voltage of the feedback signal is clamped to a charging voltage of the charging/discharging circuit via the diode for a time period beginning when the power conversion system is turned on.

5. The over-load protection device of claim 1, wherein the first detection circuit comprises:
a comparator, for receiving the feedback signal and for generating an enabling signal according to the feedback signal to control charging and discharging of the charging/discharging circuit.

6. The over-load protection device of claim 5, wherein the first detection circuit further comprises:
a flip-flop for receiving an output signal of the comparator as a clock signal, and for outputting the enabling signal.

7. The over-load protection device of claim 5, wherein the first detection circuit further comprises:
a buffer, for passing the feedback signal to the charging/discharging circuit according to the enabling signal, such that the charging/discharging circuit adjusts discharging speed according to the feedback signal.

8. The over-load protection device of claim 5, wherein the first detection circuit further comprises:
an amplifier, for amplifying the feedback signal and passing the amplified feedback signal to the charging/discharging circuit according to the enabling signal, such that the charging/discharging circuit adjusts the discharging speed according to the feedback signal.

9. The over-load protection device of claim 1, wherein the second detection circuit further comprises:
a comparator, coupled to the charging/discharging circuit, for detecting a charging voltage of the charging/discharging circuit and outputting the switching-disabling control signal when the charging voltage is discharged to a predetermined level.

10. The over-load protection device of claim 9, wherein the comparator is enabled when the over-load event occurs.

11. A power conversion system with an over-load protection device, comprising:
a transformer;
a feedback control circuit, coupled to an output terminal of the power conversion system, for outputting a feedback signal which is correlated to a load of the output terminal of the power conversion system;
a power switch, serially coupled to a primary winding of the transformer;
a PWM signal generating circuit, for generating a PWM signal to switch the power switch and to determine a duty cycle of the PWM signal according to the feedback signal;
a first detection circuit, for receiving the feedback signal and for detecting an over-load event of the power conversion system according to a voltage of the feedback signal;
a charging/discharging circuit, for charging before the over-load event occurs, and for discharging according to the over-load event; and
a second detection circuit, for detecting a discharging of the charging/discharging circuit, and for generating the switching-disabling control signal when a charging voltage of the charging/discharging circuit is discharged to a predetermined level;
wherein the first detection circuit adjusts a discharging speed of the charging/discharging circuit according to an over-load level of the power conversion system when the over-load event occurs.

12. The power conversion system with an over-load protection device of claim 11, wherein the charging/discharging circuit comprises:
a capacitor;
a charging current source, for charging the capacitor, and for stopping from charging the capacitor when the over-load event occurs, such that the capacitor discharges; and
a variable resistor, coupled to the capacitor, for providing a path for discharging the capacitor, wherein a resistance value of the variable resistor is determined according to a voltage value of the feedback signal.

13. The power conversion system with an over-load protection device of claim 11, wherein the charging/discharging circuit comprises:
a capacitor;
a charging current source, for charging the capacitor, and for stopping from charging the capacitor when the over-load event occurs, such that the capacitor discharges; and
a variable current source, coupled to the capacitor, for providing a path for discharging the capacitor, wherein a current value of the adjustable current source is determined according to a voltage value of the feedback signal.

14. The power conversion system with an over-load protection device of claim 11, wherein the charging/discharging circuit is further coupled to a diode, such that a voltage of the feedback signal is clamped to a charging voltage of the charging/discharging circuit via the diode for a time period beginning when the power conversion system is turned on.

15. The power conversion system with an over-load protection device of claim 11, wherein the first detection circuit comprises:
a comparator, for receiving the feedback signal and for generating an enabling signal according to the feedback signal to control charging and discharging of the charging/discharging circuit.

16. The power conversion system with an over-load protection device of claim 15, wherein the first detection circuit further comprises:
a buffer, for passing the feedback signal to the charging/discharging circuit according to the enabling signal, such that the charging/discharging circuit adjusts discharging speed according to the feedback signal.

17. The power conversion system with an over-load protection device of claim 15, wherein the first detection circuit further comprises:
a flip-flop for receiving an output signal of the comparator as a clock signal, and for outputting the enabling signal.

18. The power conversion system with an over-load protection device of claim 15, wherein the first detection circuit further comprises:
an amplifier, for amplifying the feedback signal and passing the amplified feedback signal to the charging/discharging circuit according to the enabling signal, such that the charging/discharging circuit adjusts the discharging speed according to the feedback signal.

19. The power conversion system with an over-load protection device of claim 11, wherein the first detection circuit further comprises:
a comparator, coupled to the charging/discharging circuit, for detecting a charging voltage of the charging/discharging circuit and outputting the switching-disabling control signal when the charging voltage is discharged to a predetermined level.

20. The power conversion system with an over-load protection device of claim 19, wherein the comparator is enabled when the over-load event occurs.
